(19) United States
(12) Patent Application Publication
(10) Pub. No.: US 2020/0374269 A1
(43) Pub. Date: Nov. 26, 2020

(54) SECURE AUDIO SYSTEMS AND METHODS

(71) Applicant: SYNAPTICS INCORPORATED, San Jose, CA (US)

(72) Inventor: Pontus Evert Lidman, San Jose, CA (US)

(21) Appl. No.: 16/420,105

(22) Filed: May 22, 2019

(51) Int. Cl. H04L 29/06; G10L 15/22; G10L 15/30; G06F 21/60; H04L 9/08; H04W 12/00

(52) U.S. Cl. CPC H04L 63/0428; G10L 15/22; G10L 15/30; G06F 21/602; G10L 15/08; H04L 63/10; H04W 12/001; G10L 2015/223; H04L 9/0869

(57) ABSTRACT

Systems and methods for securing audio content in an audio system include a first operating environment executing an audio application and facilitate communications with a server, and a trusted audio processing environment having audio input/output circuitry, a digital signal processor, a tamperproof memory storing a root key serving as a hardware root-of-trust, a key derivation component configured to derive an encryption key or decryption key from the root key and seeding information associated with a server and/or the audio application, an encryption component configured to encrypt the processed audio signal producing an encrypted audio output signal which is accessible to the first operating environment which may transmit the encrypted audio output signal to the server for further processing. A decryption component is configured to decrypt protected audio content received from the server.

### TECHNICAL FIELD

The present disclosure, in accordance with one or more embodiments, relates generally to audio processing systems and methods, and more particularly, for example, to audio systems and methods providing secure input and/or output audio processing.

### BACKGROUND

Modern electronic devices commonly include audio input and/or output processing components to facilitate voice command processing, oral communications, device input and output, media playback and other audio applications. For example, voice-interaction devices, such as intelligent voice assistants and smart speakers, receive audio through one or more microphones, process the received audio input to detect human speech, and identify one or more trigger words and/or voice commands for controlling the voice-interaction device.

In many environments, the voice input may include personal, private and/or confidential information that may be vulnerable to attack from other systems. A person may use voice input for sensitive information that includes, for example, passwords, financial account information, and personal medical information. In some of these devices, the received audio may be forwarded to a server across a network (e.g., the Internet or the cloud) for processing. Further, many devices continually receive and process audio input while not in active use (e.g., the system may listen for and detect trigger words and voice commands), which may include private conversations that were not intended to be processed by the voice-interaction device.

Similarly, the voice-interaction device may receive audio data for playback through a speaker or headset, and this audio data may be susceptible to unwanted copying or hacking. For example, users in a private Voice-over-IP (VoIP) call may desire protections to prevent the private conversation from being retained electronically and/or to avoid exposure of the private conversation to an outside attack. Media providers may also desire to restrict playback of audio content to an approved audio device, without allowing the content to be stored, copied or played back on other devices.

In view of the foregoing, there is a continued need for improved systems and methods for securing audio input and/or output in audio processing systems.

### SUMMARY

Various embodiments of the present disclosure provide improved systems and methods for securing audio content in an audio processing system. To protect the user-generated audio data from exposure to hackers or other unauthorized parties, embodiments of the present disclosure create a secure path from audio capture components to a networked service provider or cloud application. The secure path may include a trusted execution environment that provides strong encryption through a key ladder and hardware root-of-trust. Embodiments of the present disclosure are also directed to securing audio content during playback and may be used to protect content delivered in paid music subscription services, confidential audio data picked up from the end-user device, and other applications where confidentiality and/or limited distribution of the audio content is desired.

In various embodiments, the audio content encryption and decryption keys are generated in a trusted execution environment using a key ladder process. In this manner, the final keys are not exposed to the software on the device and are protected from attempts to hack the device software. The trusted execution environment controls access to the information that may be shared with audio applications operating in the non-trusted environment. In some embodiments, captured audio is processed in the trusted execution environment and encrypted before output to the non-trusted environment. The trusted execution environment may also extract audio features for use by the audio applications. For example, while in a low power mode the audio processor may detect the presence of speech or a trigger word in the captured audio and provide a notification to the non-trusted environment to switch to an active state.

In some embodiments, a system includes a first operating environment comprising a processor and memory configured to execute an audio application and facilitate communications with a server and a trusted audio processing environment. The trusted audio processing environment may include audio input circuitry configured to receive an audio input signal, a secure memory configured to store the audio input signal, a digital signal processor configured to process the audio input signal for use with the audio application, a tamperproof memory storing a root key for the trusted audio processing environment, a key derivation component configured to derive an encryption key from the root key and seeding information associated with a server and/or an audio application, and an encryption component configured to encrypt the processed audio signal producing an encrypted audio output signal. The encrypted audio output signal is accessible to the first operating environment, and the audio application may be configured to transmit the encrypted audio output signal to the server for further processing.

The trusted audio processing environment may further include a decryption key derivation component configured to derive a decryption key from the root key and seeding information associated with the server and/or the audio application, a decryption module configured to decrypt an encrypted audio output signal received from the audio application, and audio output components configured to output the decrypted audio output signal.

In some embodiments, a method includes executing an audio application in a first operating environment of an audio device, receiving an audio input signal in a trusted audio processing environment of the audio device, processing, in the trusted audio processing environment, the audio input signal for use with the audio application, deriving an encryption key in the trusted audio processing environment, encrypting the audio signal in the trusted audio processing environment to produce an encrypted output audio signal, transmitting the encrypted audio output signal to the audio application in the first operating environment, and transmitting the encrypted audio output signal to a server for further processing.

The method may further include receiving, by the audio application in the first operating environment, an encrypted audio output signal from the server, deriving, in the trusted audio processing environment, a decryption key from a root key and seeding information associated with the server and/or the audio application, decrypting, in the trusted audio processing environment, the encrypted audio output signal to produce a decrypted audio output signal, and outputting the decrypted audio output signal. The method may further include using, in the trusted audio processing environment, the decrypted audio output signal for echo processing of the audio input signal, and receiving a non-secure audio signal from the audio application and process the non-secure audio signal in the trusted audio processing environment for output.

A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

Aspects of the disclosure and their advantages can be better understood with reference to the following drawings and the detailed description that follows. It should be appreciated that like reference numerals are used to identify like elements illustrated in one or more of the figures, where showings therein are for purposes of illustrating embodiments of the present disclosure and not for purposes of limiting the same. The components in the drawings are not necessarily to scale, emphasis instead being placed upon clearly illustrating the principles of the present disclosure.

FIG. 1 illustrates an example audio processing system, in accordance with one or more embodiments.

FIG. 2 illustrates an example operation of a secure audio processing system, in accordance with one or more embodiments.

FIG. 3 illustrates an example embodiment of a secure audio processing system, in accordance with one or more embodiments.

FIGS. 4A-B are flow charts illustrating an example operation of a secure audio processing system, in accordance with one or more embodiments.

FIG. 5 is a flow chart illustrating an example operation of secure audio input processing, in accordance with one or more embodiments.

FIG. 6 is a flow chart illustrating an example operation of secure audio output processing, in accordance with one or more embodiments.

### DETAILED DESCRIPTION

The present disclosure describes improved systems and methods for securing audio data in audio processing systems. In some embodiments, a voice-interaction system suitable for use in an end-user's home is configured to process user-generated audio data. To protect the user-generated data from exposure to hackers or other unauthorized parties, embodiments of the present disclosure create a secure path from audio capture components (e.g., a microphone) to a networked service provider or cloud application. The secure path may include a trusted execution environment that provides strong encryption through a key ladder and hardware root-of-trust.

Embodiments of the present disclosure are also directed to securing audio content during playback and may be used to protect content delivered in a paid music subscription service, confidential audio data picked up from the end-user device, and other applications where confidentiality and/or limited distribution of the audio content is desired. The audio data stored on the audio processing device may be protected from extraction or tampering. The systems and methods disclosed herein also include protections for audio content (e.g., commercial audio streams) used as an echo reference signal for echo cancellation, providing end-to-end protection for both user-generated audio content received at a microphone and protected audio content played through a speaker.

In various embodiments, audio content encryption and decryption keys are generated in a trusted execution environment using a key ladder. In this manner, the final keys are not exposed to the software on the device and are protected from attempts to hack the device software. A corresponding key derivation process is executed on a remote device (e.g., cloud application, network server, client device) to generate encryption and/or decryption keys with the same root key material present in the audio device and the remote server. The seeding of the root key material can be performed with a high security process (e.g. hand-carry by courier) as appropriate for the intended use.

The audio input and output processing, content encryption and decryption, and key derivation components are secured by a trusted execution environment. In various embodiments, the trusted execution environment may be implemented as a dedicated integrated circuit or as a secure execution environment on system-on-chip that includes both trusted and non-trusted operating environments. The trusted execution environment may include a secure processor, operating system, and secure memory that are not accessible by resources outside of the trusted operating environment.

In various embodiments, the trusted execution environment controls the information that may be shared with external applications (e.g., audio middleware) operating in the non-trusted environment. In some embodiments, captured audio may include a mono audio signal, a stereo audio signal and/or a multi-channel audio signal including three or more channels. The captured audio is processed in the trusted execution environment and encrypted before output to the non-trusted environment. The trusted execution environment may also extract audio features for use by the audio middleware. For example, while in a low power mode the audio processor may detect the presence of speech or a trigger word in the captured audio and provide a notification to the non-trusted environment to switch to an active state.

Playback of protected audio content may also be controlled in the trusted execution environment. Encrypted audio content may be received from the non-trusted environment and decrypted using a decryption key derived through the key ladder process. The audio content may then be processed for playback through audio output components, which may include one or more speakers. In various embodiments, the protected audio content may include a mono audio signal, a stereo audio signal and/or a multi-channel audio signal including three or more channels. In some embodiments, the protected audio content may be mixed or otherwise combined with non-protected audio received from the audio middleware before output. The audio effects processing and mixing are performed in the trusted execution environment. In some embodiments, the trusted execution environment includes both audio input components and audio output components, and the audio output content is fed from the playback stage to the audio input processing stage as the echo reference for acoustic echo cancellation.

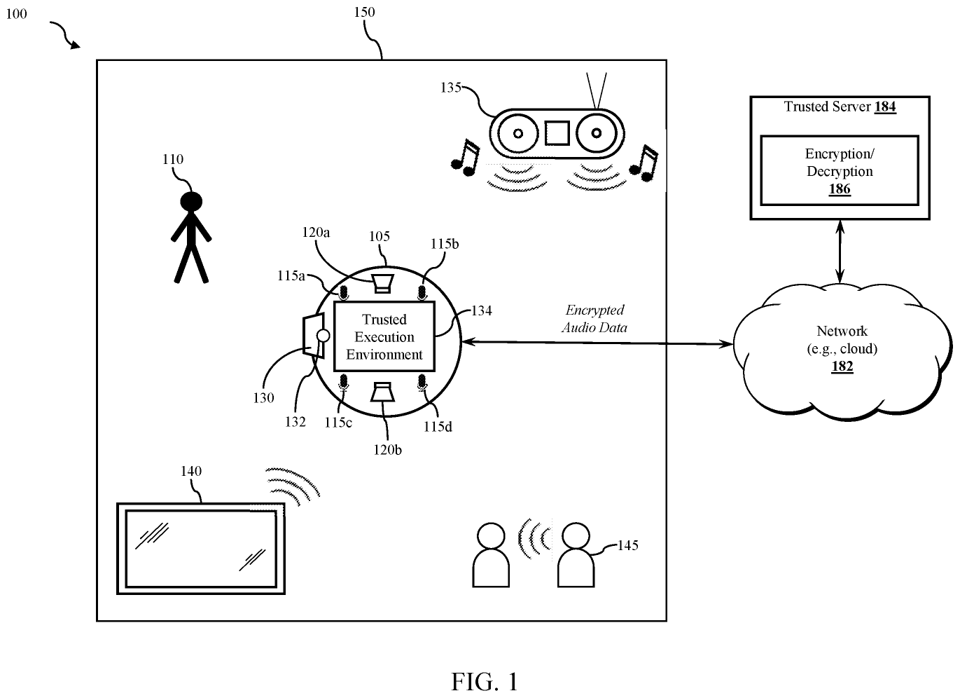

Various embodiments of the present disclosure will now be described in further detail with reference to the figures. FIG. 1 illustrates an example operating environment 100 for an audio processing device 105, according to one or more embodiments of the disclosure. The audio processing device 105 may be any device that captures audio input and/or facilitates output of audio content. In the illustrated embodiment, the audio processing device 105 is a voice-interaction device located in an interior of a room 150, but it is contemplated that the audio processing device 105 may include other devices (e.g., mobile phone, smart speaker, media streaming system and other audio systems) in other use environments (e.g., automobile, conference room, retail establishment, and other environments where audio input and/or output is used).

The audio processing device 105 may include one or more audio sensing components 115a-115d (e.g., microphones) for capturing audio and one or more audio output components (e.g., speakers) 120a-120b to provide audio output to the user. In the illustrated embodiment, the audio processing device 105 includes four microphones and two speakers 120a and 120b, but other configurations may be implemented in accordance with various embodiments of the present disclosure. The audio processing device 105 may also include at least one user input/output component 130, such as a touch screen display and an image sensor 132, buttons, dials, or other components providing additional input/output mode(s) for user interaction with the audio processing device 105.

The audio processing device 105 is configured to sense soundwaves from the operating environment 100 via the audio sensing components 115a-115d, and generate an audio input signal, which may comprise one or more audio input channels. The operating environment 100 may include a target audio source 110 (e.g., a user providing voice commands) and one or more noise sources 135, 140 and 145. The target audio source 110 may be any source that produces target audio detectable by the audio processing device 105. The noise sources 135-145 may include, for example, a loud speaker 135 playing music, a television 140 playing a television show, movie or sporting event, and background conversations between non-target speakers 145. It will be appreciated that other noise sources may be present in various operating environments.

The audio processing device 105 processes the audio input signal to detect and enhance an audio signal received from the target audio source 110. The input audio processing may include noise cancelling, echo cancelling, spatial processing and other audio processing techniques to prepare the input audio signal for an intended use. For example, a spatial filter (e.g., beamformer) may be used to identify the direction of the target audio source and, using constructive interference and noise cancellation techniques, output an enhanced audio signal that enhances the sound (e.g., speech) produced by the target audio source 110. The enhanced audio signal may then be transmitted to other components within the audio processing device 105, such as a speech recognition engine or voice command processor, or as an input signal to a Voice-over-IP (VoIP) application during a VoIP call.

The audio input processing is performed in a trusted execution environment 134, which includes tamper resistant hardware, secure memory and encryption/decryption of processed audio signals. In one embodiment, the processed audio signal is encrypted before sharing outside the trusted execution environment 134. The encrypted audio signal may be shared, for example, with non-secure components of the audio processing device 105, and/or a trusted server 184 across a network 182 (e.g., the Internet or cloud). The server 184, includes corresponding encryption/decryption modules 186 to derive the encryption and decryption keys (e.g., using a multistage key ladder process) for securing the audio data.

In various embodiments, aspects of the audio processing, speech processing, and command processing may be performed remotely by the server 184. For example, the trusted execution environment 134 may receive captured audio, detect the presence of speech, encrypt speech segments and forward the encrypted audio segments to the server 184 for further processing that may include speech recognition and/or voice command processing. The server 184 may respond, for example, by providing commands/instructions to the audio processing device 105.

The server 184 may also deliver protected audio content to the audio processing device 105. The server 184 encrypts the protected audio content using a derived encryption key associated with the audio processing device 105, transmits to the encrypted audio content to the audio processing device 105, which forwards the encrypted audio content to the trusted execution environment 134 for decryption and output through the speakers 120a-b. In various embodiments, the audio processing device 105 may operate as a communications device facilitating secure VoIP communications across the network 182. The audio processing device 105 may also be configured to securely combine protected audio with non-protected audio and/or other media types (e.g., video).

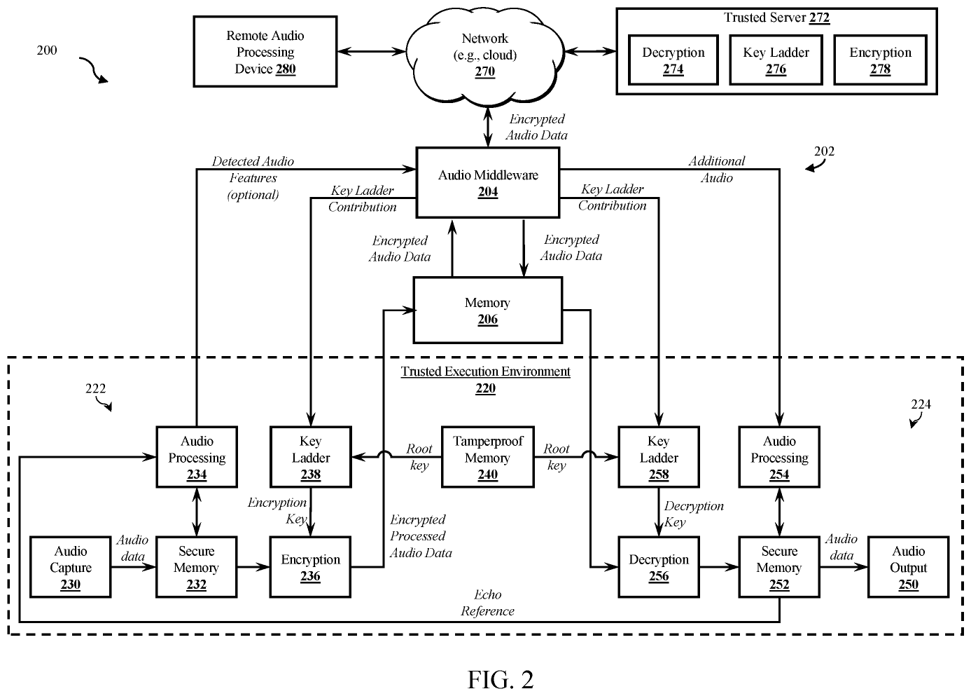

Referring to FIG. 2, operation of a secure audio processing system 200 will now be described, in accordance with one or more embodiments. The secure audio processing system 200 includes a trusted execution environment 220 providing secure audio input and output processing and non-secure components 202. The non-secure components 202 include components to facilitate operation of an audio device, including audio middleware 204 facilitating communications with a trusted server 272 across a network 270, and a non-secure memory 206.

The trusted execution environment 220 includes secure audio input processing components 222 and secure audio output processing components 224. The secure audio input processing components 222 include audio capture components 230 (e.g., one or more microphones) for capturing sound from an environment (e.g., a voice command from the user, environmental noise). The captured audio is stored in a secure memory 232 that is accessible only through the trusted execution environment 220. Audio processing components 234 perform input audio processing such as target source enhancement, beam forming, spatial processing, echo cancellation, noise reduction, speech detection and other audio input processing as appropriate for the requirements of the secure audio processing system 200.

The processed audio data is encrypted through encryption component 236 before the processed audio data is shared with the non-secure components 202. The encryption component 236 implements an encryption algorithm with an appropriate level of security for the system objectives, which may include a data encryption standard (DES) algorithm, an advanced encryption standard (AES) algorithm, a Triple-DES algorithm, or other content encryption algorithm. The encryption key is derived through a key ladder component 238 that receives a root key from tamperproof memory 240 and data provided by the audio middleware 204 (e.g., data associated with a trusted server 272, such as a server identifier). The key ladder component 238 implements a multi-stage key derivation process that utilizes the root key and other seeding information to derive intermediate keys, which are used to derive the final encryption key that is used to encrypt the audio content. The tamperproof memory 240 securely stores the root key, which is kept secret and may operate as a hardware root-of-trust within the trusted execution environment. In some embodiments, the tamperproof memory 240 may comprise a one-time programmable memory.

The encryption component receives the encryption key from the key ladder component 238 and encrypts the processed audio data for output to the non-secure memory 206. In some embodiments, the encrypted processed audio data is forwarded to the trusted server 272 (e.g., a cloud server) through the network 270. The server 272 includes complementary decryption components 274, key ladder components 276 and encryption components 278 to decrypt the audio data received from the trusted execution environment 220 and/or encrypt audio data for playback through the trusted execution environment 220. In various embodiments, a secure communications path is formed between the trusted server 272 and the trusted execution environment 220, allowing for secure processing of captured audio data (e.g., speech, commaned and other audio processing may be performed on the trusted server 272) across a network.

In various embodiments, the audio processing component 234 may also provide non-secure audio data, such as detected audio features to the audio middleware 204. For example, the secure audio processing system 200 may be in a low power/sleep mode during which the trusted execution environment 220 listens for speech activity and/or trigger words. The audio processing component 234 may detect speech and/or the presence of a trigger word and signal the audio middleware to enter an active, higher-power mode.

The secure audio output processing components 224 provide further protection of audio content through a secure audio output process. The secure audio output processing components 224 are configured to receive encrypted audio data, derive a decryption key, and decrypt the audio data for output. The encrypted audio data may include any type of encrypted audio, including audio data generated by the secure audio processing system 200, audio data received from a server (e.g., trusted server 272) such as an encrypted music stream, and audio data generated by a remote audio processing device 280 (e.g., audio for a VoIP call). In one embodiment, the audio data is encrypted by the trusted server 272 using the root key for the trusted execution environment 220 and other key derivation input to derive an encryption key. The encrypted audio data is delivered to the audio middleware 204 and stored (or buffered) in the non-secure memory 206. The encrypted audio stream is received by decryption components 256 to decrypt the audio content using a decryption key derived by the key ladder 258 in a similar process as used by the trusted server 272 for encryption of the audio stream. In various embodiments, the key ladder 258 receives the root key and source identifier and derives the decryption key by unwrapping a sequence of encrypted keys through a key ladder process.

In some embodiments, a global key may be used to encrypt/decrypt the audio content. The global key may be encrypted/decrypted using the device specific encryption key which is derived through the key ladder process. For example, the trusted server 272 could generate device specific encrypted global keys for each device (e.g., using the key ladder process for each specific device) allowing the same encrypted audio data (i.e., audio data encrypted with global key) to be securely transferred across multiple devices. The key ladder 258 derives the device specific decryption key which is used to decrypt the encrypted global key for decrypting the received audio content. In a VoIP call, for example, the trusted server 272 may share the global encryption key with each VoIP client at the start of the VoIP session, by encrypting the global key using the device specific encryption key for each respective client. Each VoIP client may receive and decrypt the global key, which may then be used to encrypt and decrypt VoIP communications (i.e., audio data generated during the call). The audio communications may be transmitted directly between devices and/or through the trusted server.

The global key may be generated by or provided to the trusted execution environment 220 and/or the trusted server 272. The encrypted global key may be transmitted from a client to the server, from a server to a client and/or from a client to a client. The encrypted global key may be transmitted along with the audio content outside the trusted execution environment (e.g., to another device).

As illustrated in FIG. 2, the decrypted audio content may be stored in a secure memory 252 and processed by the audio processing component 254 for output to the audio output component 250 (e.g., one or more speakers or a headphones). In some embodiments, the decrypted, processed audio data stored in the secure memory 252 is provided as an echo reference signal to the audio processing components 234. In this manner, the decrypted audio data is maintained in the trusted execution environment and may be used to remove the audio output from the captured audio input signal in a secure manner Depending on the configuration of the device, the audio input signal, the audio output signal and/or the echo reference may include mono audio signals, stereo audio signals and/or multi-channel audio signals comprising three or more channels. In some embodiments, the protected audio data may be mixed with unprotected audio data received from the audio middleware. In these embodiments, the audio processing is performed in the trusted execution environment and the decrypted audio content remains in the trusted execution environment.

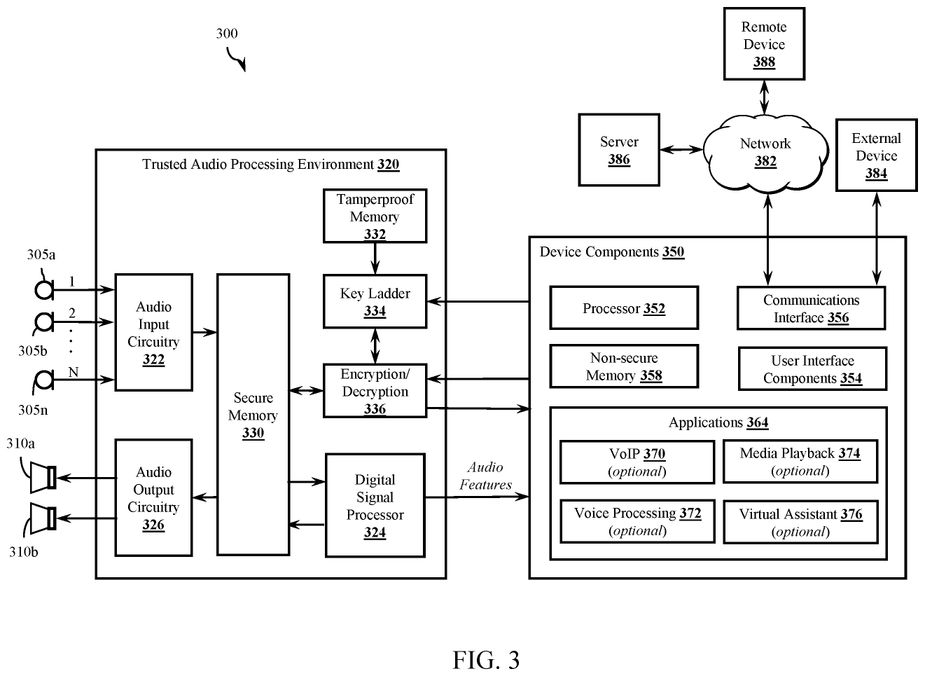

FIG. 3 illustrates an example implementation of a secure audio system 300, according to various embodiments of the disclosure. The secure audio system 300 includes at least one audio sensor 305a-n, at least one speaker 310a-b, a plurality of device components 350, and a trusted audio processing environment 320.

The at least one audio sensor 305a-n comprises one or more sensors, each of which may be implemented as a transducer that converts audio inputs in the form of sound waves into an audio signal. In the illustrated environment, the at least one audio sensor 305a-n is an audio sensor array that comprises a plurality of microphones, each generating an audio input signal which is provided to audio input circuitry 322 of the trusted audio processing environment 320. In one embodiment, a multichannel audio signal is generated, with each channel corresponding to an audio input signal from one of the microphones. In other embodiments, the audio signal may include a two-channel stereo audio signal and/or a mono channel audio signal. In various embodiments, the audio input circuitry 322, may include an interface to the at least one audio sensor 305a-n, anti-aliasing filters, analog-to-digital converter circuitry, echo cancellation circuitry, and other audio processing circuitry and components.

In various embodiments, the digital signal processor 324 may be configured to perform echo cancellation, noise cancellation, target signal enhancement, post-filtering, and other audio signal processing functions. In some embodiments, the secure audio system 300 is configured to enter a low power mode (e.g., a sleep mode) during periods of inactivity, and the digital signal processor 324 is configured to listen for a trigger word and wake up one or more of the device components 350 when the trigger word is detected.

The audio output circuitry 326 processes audio signals received from the digital signal processor 324 for output to at least one speaker, such as speakers 310a and 310b. In various embodiments, the audio output circuitry 326 may include a digital-to-analog converter that converts one or more digital audio signals to analog and one or more amplifiers for driving the speakers 310a-310b. In other embodiments, the audio output circuitry 326 may provide output other audio playback devices such as headphones and earbuds through wired and/or wireless communications.

The trusted audio processing environment 320 further includes components for encrypting and/or decrypting audio signals, including a secure memory 330, tamperproof memory 332, key ladder component 334 and encryption/decryption components 336. The key ladder component 334 receives a root key from the tamperproof memory 332 and context information from the device components 350, such as a server identifier or key ladder configuration, and derives encryption and decryption keys. The encryption/decryption components 336 encrypt audio data before sending to the device components 350 and decrypts audio received from the device components 350.

The secure audio system 300 may be implemented in a variety of devices including a voice-interaction system, intelligent voice assistant, mobile phone, tablet, laptop computer, desktop computer, or automobile. The device components 350 includes various hardware and software components comprising a non-secure operating environment that facilitates the operation of the secure audio system 300. The trusted audio processing environment 320 may be configured for various audio input and/or output applications, including the number of audio sensors (if any), number of output channels (if any) and audio processing to be performed.

In various embodiments the trusted audio processing environment 320 may be implemented as an integrated circuit comprising analog circuitry, digital circuitry, secure and tamperproof memory and a digital signal processor, which is configured to execute program instructions stored in firmware. In some embodiments, the trusted audio processing environment 320 may be implemented as a system-on-chip or may be combined with the device components 350 in a single hardware component that includes both trusted and non-trusted operating environments.

In the illustrated embodiment, the device components 350 include a processor 352, user interface components 354, a communications interface 356 for communicating with external devices and networks, such as network 382 (e.g., the Internet, the cloud, a local area network, or a cellular network) and external device 384 (e.g., a mobile device), and a non-secure memory 358. The device components 350 facilitate a non-secure/non-trusted operating environment that controls the operation of the secure audio system 300.

The device components 350 may further include one or more applications 364 such as optional Voice-over-IP (VoIP) 370, voice processing 372, media playback 374, and virtual assistant 376 applications. Applications 364 include instructions which may be executed by processor 352 and associated data and may include device and user applications. Voice processing 372 may interface with the digital signal processor 324 and server 386 to facilitate speech recognition and detection of trigger words and voice commands from protected audio. The virtual assistant module 376 is configured to provide a conversational experience to the target user and facilitate the execution of user commands (e.g., voice commands identified by the server 386). The applications 364 may also include a VoIP application facilitating voice communications with one or more external devices such as the external device 384 or a remote device 388. The applications 364 may also include media playback 374 application to manage subscription services and/or identify audio files or audio streams for playback from one or more server, such as server 386.

The processor 352 and digital signal processor 324 may each comprise one or more of a processor, a microprocessor, a single-core processor, a multi-core processor, a microcontroller, a programmable logic device (PLD) (e.g., field programmable gate array (FPGA)), a digital signal processing (DSP) device, or other logic device that may be configured, by hardwiring, executing software instructions, or a combination of both, to perform various operations discussed herein for embodiments of the disclosure. The device components 350 are configured to interface and communicate with the trusted audio processing environment 320, such as through a bus or other electronic communications interface. In some embodiments, the processor 352 and digital signal processor 324 may be implemented on a single processor configured to securely execute separate trusted and non-trusted environments.

It will be appreciated that although the trusted audio processing environment 320 and the device components 350 are shown as incorporating a combination of hardware components, circuitry and software, in some embodiments, at least some or all of the functionalities that the hardware components and circuitries are configured to perform may be implemented as software modules being executed by the processor 352 and/or digital signal processor 324 in response to software instructions and/or configuration data, stored in the memory 358 or firmware of the digital signal processor 324.

The memory 358 and other memory components disclosed herein may be implemented as one or more memory devices configured to store data and information, including audio data and program instructions. Memory 358 may comprise one or more various types of memory devices including volatile and non-volatile memory devices, such as RAM (Random Access Memory), ROM (Read-Only Memory), EEPROM (Electrically-Erasable Read-Only Memory), flash memory, hard disk drive, and/or other types of memory. In some embodiments, audio is received and encrypted by the trusted audio processing environment and the encrypted audio is stored in a local storage, such as non-secure memory 358. The stored encrypted audio data may be played back through the device 300 but will not be able to be decrypted and played from other devices. In some embodiments, the local storage may include a USB drive and the encrypted audio may only be decrypted and played when connected to the system 300.

The user interface components 354 may include a display, user input components (e.g., a touchpad display, a keypad, one or more buttons, dials or knobs, and/or other input/output components) configured to enable a user to directly interact with the secure audio system 300. The user interface components 354 may also include one or more sensors such as one or more image sensors (e.g., a camera) for capturing images and video.

The communications interface 356 facilitates communication between the secure audio system 300 and external devices. For example, the communications interface 356 may enable Wi-Fi (e.g., 802.11) or Bluetooth connections between the secure audio system 300 and one or more local devices, such as the external device 384, or a wired or wireless router providing network access to a server 386 or remote device 388 via network 382. In various embodiments, the communications interface 356 may include other wired and wireless communications components facilitating direct or indirect communications between the secure audio system 300 and one or more other devices and networks.

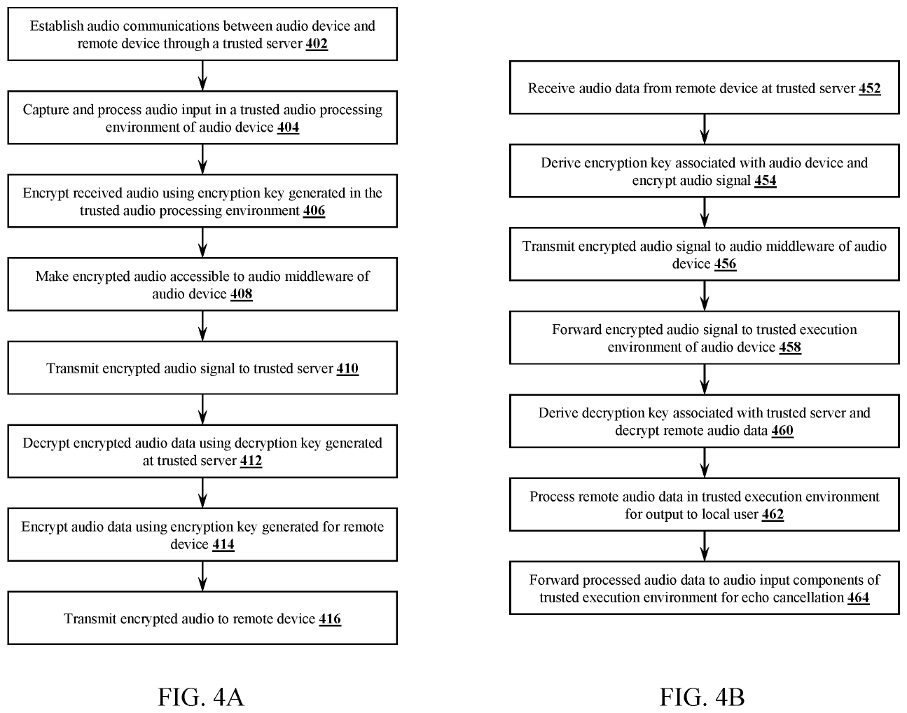

Referring to FIGS. 4A-B, an example operation of a secure audio system for facilitating a Voice-over-IP (VoIP) call will now be described. At step 402, a VoIP call is initiated with a remote device (e.g., remote device 388 of FIG. 3) and the VoIP application (e.g., VoIP application 370 of FIG. 3) establishes a secure connection through a trusted server (e.g., server 386.) In various embodiments, each device on the call includes a trusted audio processing environment allowing secure, encrypted communications between the audio input/output components and the server 386. The audio capture components sense speech and noise in the environment and process the received audio signals in the trusted audio processing environment in step 404, for example to cancel noise and echo and produce a clean speech signal. The processed audio signal is then encrypted using an encryption key generated in the trusted audio processing environment (step 406) and the encrypted audio signal is made accessible to the audio middleware of the audio device. (step 408). As discussed herein, the encryption key may be derived through a multistage key ladder process based on a secret root key stored in the trusted audio processing environment and seeding information associated with the trusted server. In some embodiments, the encryption key is derived one time for a VoIP session, and reused for further communications during the VoIP session.

In step 410, the encrypted audio signal is transmitted to the trusted server. The trusted server decrypts the encrypted audio data using decryption key generated in a trusted execution environment of the trusted server, in step 412. The decryption key is derived through a multistage key ladder process that corresponds to the encryption key derivation process of step 406. Next, the server encrypts the audio for delivery to the remote device (step 414) and transmits the encrypted audio (step 416). The remote device receives the transmitted audio, decrypts the received audio in local trusted environment and plays the audio content for the remote user.

During the process of FIG. 4A, audio content may be captured by the remote device and transmitted to the local audio device through the trusted server. In step 452, the trusted server receives the audio data from the remote device and accesses the audio content (e.g., by decrypting the audio data). In step 454, the trusted server derives an encryption key associated with the local audio device and encrypts the audio signal. The encrypted audio signal is then transmitted to the audio middleware of the audio device in step 456. The middleware forwards the encrypted audio signal to audio output components of the trusted execution environment of the audio device in step 458. The trusted execution environment derives the decryption key associated with the trusted server and decrypts the remote audio content in step 460. The audio content is then processed in the trusted execution environment for output to the local user in step 462. In step 464, the processed audio data is forwarded to audio input components of the trusted execution environment for use in echo cancellation (step 404).

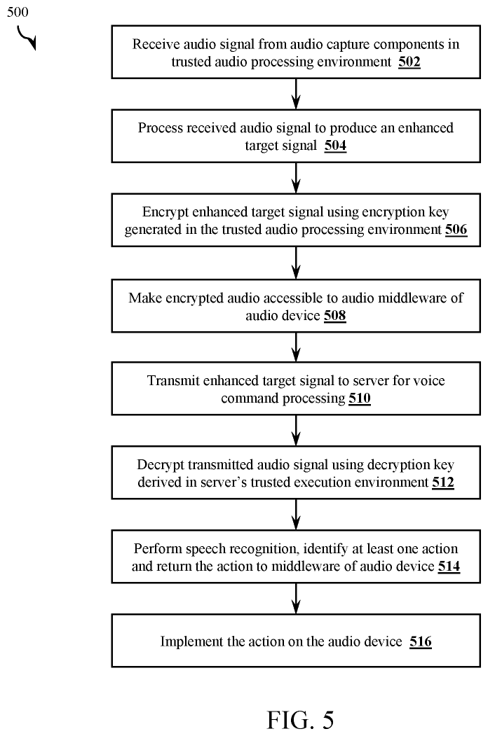

Referring to FIG. 5, embodiments for voice command processing will now be described. A voice processing method 500 includes receiving an audio signal from audio capture components in a trusted audio processing environment in step 502. The audio signal is stored in a secure memory and processed to remove echo, suppress noise and enhance a target signal for voice processing in step 504. The target audio signal is encrypted using an encryption key generated in the trusted audio processing environment in step 506. The encrypted audio signal is made accessible to the audio middleware of the audio device (step 508) and transmitted to the secure server in step 510. The server decrypts the audio signal using a decryption key derived in the server's trusted execution environment in step 512. The server then performs speech recognition, identifies a voice command, determines an associated action and returns the action to the audio device in step 514. The action is implemented by an application running on the audio device in step 516.

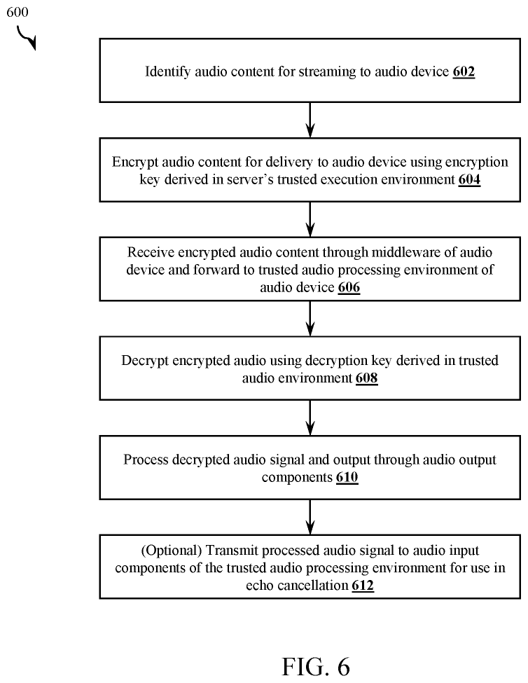

Referring to FIG. 6, an embodiment of an audio playback method 600 will now be described. In step 602, a server identifies audio content for streaming to a secure audio device. The audio content is encrypted using an encryption key associated with the audio device in step 604. The encryption key is derived in a trusted execution environment of the server using a multistage key derivation process (e.g., key ladder process), including a secret root key associated with audio device and seeding information associated with the server. The encrypted content is received by the middleware of the audio processing device and forwarded to the trusted audio processing environment in step 606. The encrypted audio is decrypted using a decryption key derived in the trusted audio environment in step 608 and processed for output in step 610. In some embodiments, the processed audio signal is provided to input components of the trusted audio processing environment for use in echo cancellation in step 612.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A system comprising:
a first operating environment comprising a processor and memory configured to execute an audio application and facilitate communications with a server;
a trusted audio processing environment comprising:
audio input circuitry configured to receive an audio input signal;
a secure memory configured to store the audio input signal;
a digital signal processor configured to process the audio input signal for use with the audio application;
a tamperproof memory storing a root key for the trusted audio processing environment, the root key comprising hardware root-of-trust;
a key derivation component configured to derive an encryption key from the root key and seeding information associated with a server and/or an audio application;
an encryption component configured to encrypt the processed audio signal producing an encrypted audio output signal, wherein the encrypted audio output signal is accessible to the first operating environment; and
wherein the audio application is configured to transmit the encrypted audio output signal to the server for further processing.

2. The system of claim 1, wherein a secure communications path is established between the trusted audio processing environment and the server.

3. The system of claim 1, wherein the audio application comprises a voice command processing application and/or a Voice-over-IP application.

4. The system of claim 1, further comprising audio sensing components configured to sense soundwaves and produce the audio input signal.

5. The system of claim 1, wherein the trusted audio processing environment further comprises:
a decryption key derivation component configured to derive a decryption key from the root key and seeding information associated with the server and/or the audio application;
a decryption module configured to decrypt an encrypted audio output signal received from the audio application; and
audio output components configured to output the decrypted audio output signal.

6. The system of claim 5, wherein the trusted audio processing environment is configured to use the decrypted audio output signal for echo processing of the audio input signal.

7. The system of claim 5, wherein the trusted audio processing environment is further configured to receive a non-secure audio signal from the audio application and process the non-secure audio signal in the trusted audio processing environment for output.

8. The system of claim 1, wherein the key derivation component is configured to execute a multistage key ladder process.

9. The system of claim 1, wherein the audio application is further configured to receive an instruction from the server associated with the audio input signal and implement the instruction in the first operating environment.

10. A method comprising:
executing an audio application in a first operating environment of an audio device;
receiving an audio input signal in a trusted audio processing environment of the audio device;
processing, in the trusted audio processing environment, the audio input signal for use with the audio application;
deriving an encryption key in the trusted audio processing environment;
encrypting the audio signal in the trusted audio processing environment to produce an encrypted output audio signal;
transmitting the encrypted audio output signal to the audio application in the first operating environment; and
transmitting the encrypted audio output signal to a server for further processing.

11. The method of claim 10, wherein deriving the encryption key further comprises accessing a root key stored in the trusted audio processing environment.

12. The method of claim 11, wherein deriving the encryption key further comprises receiving seed information associated with the server and/or the audio application.

13. The method of claim 10, wherein a secure communications path is established between the trusted audio processing environment and the server.

14. The method of claim 10, wherein the audio application comprises a voice command processing application and/or a Voice-over-IP application.

15. The method of claim 10, further comprising sensing soundwaves to produce the audio input signal.

16. The method of claim 10, further comprising:
receiving, by the audio application in the first operating environment, an encrypted audio output signal from the server;
deriving, in the trusted audio processing environment, a decryption key from a root key and seeding information associated with the server and/or the audio application;
decrypting, in the trusted audio processing environment, the encrypted audio output signal to produce a decrypted audio output signal; and
outputting the decrypted audio output signal.

17. The method of claim 16, further comprising using, in the trusted audio processing environment, the decrypted audio output signal for echo processing of the audio input signal.

18. The method of claim 16, wherein the trusted audio processing environment is further configured to receive a non-secure audio signal from the audio application and process the non-secure audio signal in the trusted audio processing environment for output.

19. The method of claim 11, wherein deriving the encryption key comprises deriving a series of intermediate keys through a multistage key ladder process.

20. The method of claim 11, wherein the audio application is further configured to receive an instruction from the server associated with the audio input signal and implement the instruction in the first operating environment.
